(19) United States
(12) Patent Application Publication
(10) Pub. No.: US 2010/0134603 A1
(43) Pub. Date: Jun. 3, 2010

(54) THREE-DIMENSIONAL INFORMATION OUTPUT APPARATUS AND THREE-DIMENSIONAL INFORMATION OUTPUT METHOD

(75) Inventor: Yoshiyasu Itoh, Mitaka-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/510,136

(22) Filed: Jul. 27, 2009

(30) Foreign Application Priority Data
Nov. 28, 2008 (JP) 2008-304688

(51) Int. Cl. H04N 13/04

(52) U.S. Cl. 348/58; 348/E13.075

(57) ABSTRACT

According to one embodiment, a three-dimensional information output apparatus includes a detection module configured to detect a degree of three-dimensionality of a three-dimensional video, a generation module configured to generate three-dimensional information from display information based on the degree of three-dimensionality, and an output module configured to output the three-dimensional display information.

### CROSS-REFERENCE TO RELATED APPLICATIONS

This application is based upon and claims the benefit of priority from Japanese Patent Application No. 2008-304688, filed Nov. 28, 2008, the entire contents of which are incorporated herein by reference.

### BACKGROUND

1. Field

One embodiment of the invention relates to a three-dimensional information output apparatus and a three-dimensional information output method which output (display) three-dimensional broadcasting and the like.

2. Description of the Related Art

In recent years, experimental three-dimensional broadcasting has been started. For example, the three-dimensional broadcasting involves video for the right eye and video for the left eye. The three-dimensional-broadcast-compatible TVs displaceably output the video for the right eye and the video for the left eye. The displaced output provides three-dimensional video.

Jpn. Pat. Appln. KOKAI Publication No. 2006-212056 (Document 1) discloses a technique for providing three-dimensional images. For example, Jpn. Pat. Appln. KOKAI Publication No. 2006-212056 (Document 1) discloses a three-dimensional video generation technique of photographing a transmission image of an object illuminated with light from a radiation source, and displaying a three-dimensional video presented based on the transmission image, on a three-dimensional display.

As described above, various techniques for providing three-dimensional video have been proposed. However, these techniques fail to three-dimensionally display two-dimensional display information such as menus in association with the three-dimensional video. Thus, when two-dimensional display information such as a menu is superimposed on a display screen for three-dimensional broadcasting, the three-dimensional video and the two-dimensional video are mixed on one screen. This results in an unnatural video.

For example, display information for the right eye and display information for the left eye may be generated from two-dimensional display information. The display information may then be appropriately displaced so that the two-dimensional information is converted into three-dimensional information. The resulting three-dimensional display information may then be displayed. However, the degree of three-dimensionality of the three-dimensional video provided for the three-dimensional broadcasting may be different from that of the display information generated later. In this case, a video in which the video and display information having different degrees of three-dimensionality are superimposedly displayed is also unnatural.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a diagram schematically showing the configuration of a digital-broadcast-compatible television (three-dimensional information output apparatus) according to an embodiment of the invention;

FIG. 2 is a diagram illustrating three-dimensional video processing executed by a main control module of the digital-broadcast-compatible television according to the embodiment;

FIG. 3 is a flowchart showing three-dimensional video processing utilizing text information such as a caption or a ticker according to the embodiment; and

FIG. 4 is a diagram showing three-dimensional video display according to the embodiment.

### DETAILED DESCRIPTION

Various embodiments according to the invention will be described hereinafter with reference to the accompanying drawings. In general, a three-dimensional information output apparatus according to one embodiment of the invention comprises a detection module configured to detect a degree of three-dimensionality of a three-dimensional video, a generation module configured to generate three-dimensional information from display information based on the degree of three-dimensionality, and an output module configured to output the three-dimensional display information.

An embodiment of the invention will be described below with reference to the drawings.

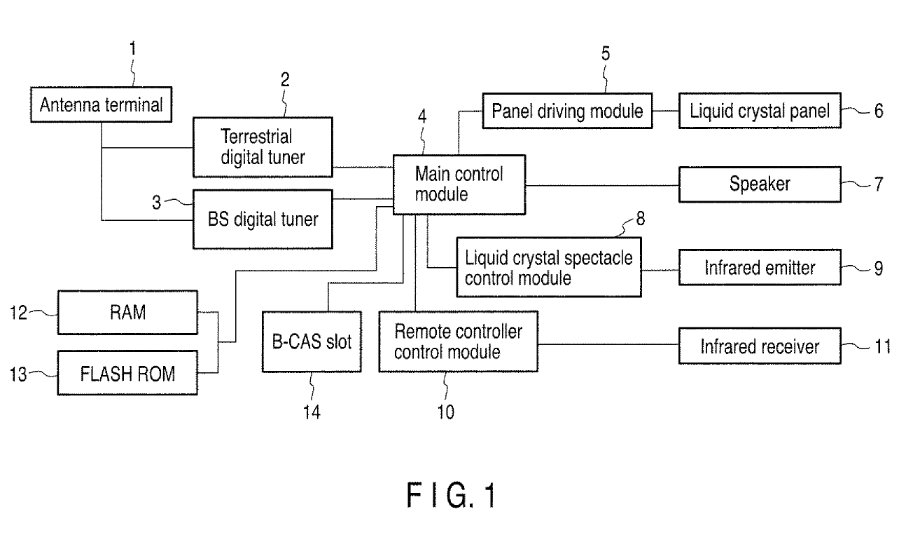

FIG. 1 is a diagram schematically showing the configuration of a digital-broadcast-compatible television (three-dimensional information output apparatus) according to an embodiment of the invention.

Broadcast signals for three-dimensional broadcasting are input to an antenna terminal 1. A terrestrial digital tuber 2 extracts a broadcast signal for a predetermined broadcasting station from the terrestrial digital broadcast signal based on a channel select instruction from a remote controller control module 10. Similarly, a BS digital tuner 3 extracts a broadcast signal for a predetermined broadcasting station from the terrestrial digital broadcast signal based on the channel select instruction from the remote controller control module 10. The remote controller control module 10 outputs the channel select instruction based on an infrared ray from a remote controller received by an infrared receiver 11.

A main control module 4 drivingly controls a driving module 5 based on a video signal contained in the extracted broadcast signal. In association with the driving of the panel driving module 5, a liquid crystal panel 6 displays the video corresponding to the video signal. The main control module 4 also inputs an audio signal contained in the extracted broadcast signal, to a speaker 7. The speaker 7 outputs sound based on the audio signal.

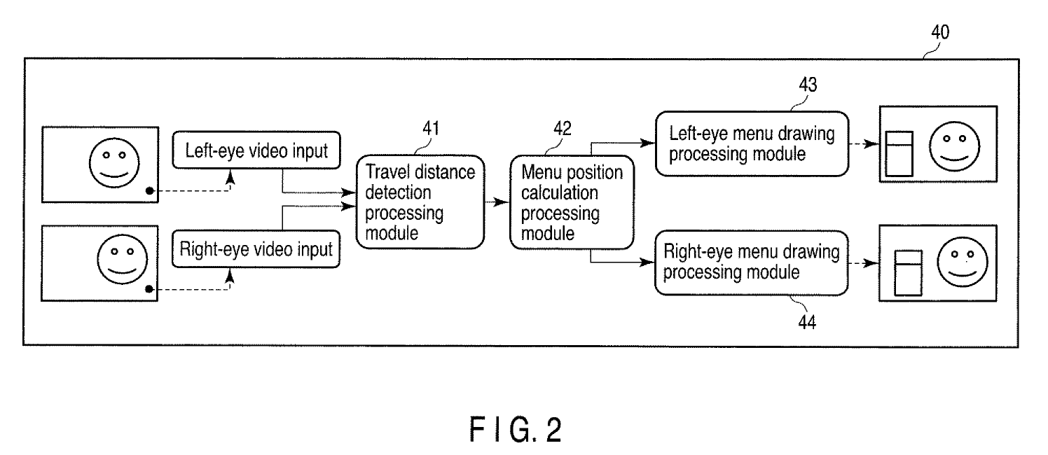

Furthermore, as shown in FIG. 2, the main control module 4 includes a three-dimensional processing module 40. The three-dimensional video processing module 40 includes a travel distance detection processing module 41, a menu position calculation processing module 42, a left-eye menu drawing processing module 43, and a right-eye menu drawing processing module 44. Three-dimensional video processing by the three-dimensional video processing module 40 will be described below in detail.

A liquid crystal glasses control module 8 and an infrared emitter 9 notify a pair of glasses with a liquid crystal shutter of a driving timing based on the video signal contained in the extracted broadcast signal. The liquid crystal glasses control module 8 and the infrared emitter 9 transmit a video signal to the pair of glasses with the liquid crystal shutter. In accordance with the provided driving timing for the liquid crystal shutter, the pair of glasses with the liquid crystal shutter drives the liquid crystal shutter to provide a three-dimensional video based on the video signal.

RAM 12 temporarily stores data required for the main control module 4. Flash ROM 13 stores a control program for the main control module 4 and display data required to display menus and the like described below. For example, a B-CAS slot 14 receives a B-CAS card required to view digital broadcasting.

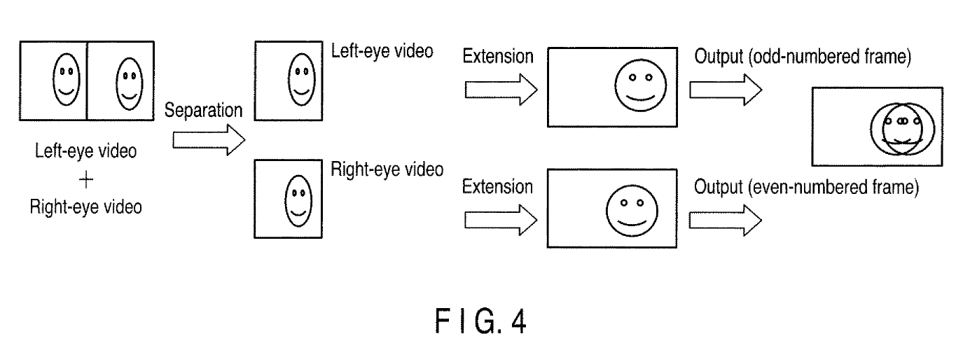

For example, as shown in FIG. 4, three-dimensional broadcasting contains plural items of frame information each of which is composed of concatenated encode information on a right-eye video and a left-eye video. The main control module 4 of the digital-broadcast-compatible television decodes the concatenated encode information to alternately output the right-eye video and the left-eye video. The pair of glasses with the liquid crystal shutter displays a video frame displaying the left-eye video, for the left eye, while displaying a video frame displaying the right-eye video, for the right eye.

With this three-dimensional image display scheme, when superimposed on each other in the same scene, the right-eye video and the left-eye video are misaligned in order to offer parallax (to provide three-dimensional display). The liquid crystal shutter switches the video to provide the misaligned right-eye video to the right eye, while providing the misaligned left-eye video to the left eye. Thus, when a user interface video (display information such as a menu) is simply superimposed on the three-dimensional broadcast video, the two-dimensional information such as a menu is displayed in a part of the three-dimensional video. This makes the viewer feel discomfort. In particular, popup menus significantly exhibit this tendency.

Furthermore, to allow a menu to be somewhat three-dimensionally displayed, a right-eye menu video and a left-eye menu video involving an appropriate parallax may be generated from a two-dimensional menu video. Then, a right-eye video for three-dimensional broadcasting may be superimposed on the generated right-eye menu video, and a left-eye video for the three-dimensional broadcasting may be superimposed on the generated left-eye menu video. However, the parallax (degree of three-dimensionality) between the right-eye video and left-eye video for the three-dimensional broadcasting is likely to fail to match that between the generated right-eye menu image and left-eye menu image. This also results in a video that makes the viewer feel discomfort.

The digital-broadcast-compatible television according to the present embodiment can execute processing described below to provide video that does not make the viewer feel discomfort. That is, the digital-broadcast-compatible television can associate the parallax (degree of three-dimensionality) between the right-eye video and left-eye video for three-dimensional broadcasting with that between the generated right-eye menu image and left-eye menu image.

For example, as shown in FIG. 2, the main control module 4 of the digital-broadcast-compatible television separates the right-eye video for three-dimensional broadcasting and the left-eye video for the three-dimensional broadcasting (the right-eye video and left-eye video to be displayed at the same time) from each other. The main control module 4 then inputs the resulting right-eye video to the travel distance detection processing module 41. The main control module 4 similarly inputs the resulting left-eye video to the travel distance detection processing module 41. The travel distance detection processing module 41 detects the amount of displacement between the resulting right-eye video and the resulting left-eye video. For example, the travel distance detection processing module 41 utilizes moving vector detection processing used for MPEG encoding to detect the amount of displacement between the resulting right-eye video and the resulting left-eye video. The travel distance detection processing module 41 determines the maximum value of a horizontal one of the detected moving vectors to be the travel distance.

In general, the degree of three-dimensionality increases consistently with the amount of displacement between the right-eye video and the left-eye video. However, the amount of displacement for three-dimensional display has an upper limit. Thus, the detection range for the moving vectors is limited. For example, the detection range for the moving vectors is limited to the given rate of horizontal pixels instead of the maximum value of the travel distance.

A menu position calculation processing module 42 receives menu display data input by flash ROM 13. The menu position calculation processing module 42 generates three-dimensional menu display data from menu display data based on the travel distance detected by the travel distance detection processing module 41. That is, the menu position calculation processing module 42 generates right-eye menu display data and left-eye menu display data from the menu display data based on the detected travel distance. The right-eye menu drawing processing module 44 draws a right-eye menu video based on the right-eye menu display data. The left-eye menu drawing processing module 43 draws a left-eye menu video based on the left-eye menu display data.

Moreover, the main control module 4 superimposes the right-eye video for the three-dimensional broadcasting on the drawn right-eye menu video to generate a right-eye superimposed video. The main control module 4 superimposes the left-eye video for the three-dimensional broadcasting on the drawn left-eye menu video to generate a left-eye superimposed video. The liquid crystal glasses control module 8 and infrared emission section 9 notify the pair of glasses with the liquid crystal shutter of the driving timing for the liquid crystal shutter based on the video signal for the three-dimensional broadcasting. The liquid crystal glasses control module 8 and infrared emission section 9 further output the right-eye superimposed video and the left-eye superimposed video. In accordance with the provided driving timing for the liquid crystal shutter, the pair of glasses with the liquid crystal shutter drives the liquid crystal shutter to provide a three-dimensional video based on the right-eye superimposed video and the left-eye superimposed video. That is, the pair of glasses with the liquid crystal shutter displays a video frame displaying the left-eye superimposed video, for the left eye, while displaying a video frame displaying the right-eye superimposed video, for the right eye.

The amount of displacement between the right-eye menu display data and the left-eye menu display data corresponds to the detected travel distance. Alternatively, the amount of displacement between the right-eye menu display data and the left-eye menu display data may corresponds to a travel distance slightly longer than the detected one. That is, given that the detected travel distance is n pixels, the amount of displacement between the right-eye menu display data and the left-eye menu display data is (n+α) pixels. Thus, a menu can be displayed in association with a video for the three-dimensional broadcasting which is closest to the viewer or displayed in front of the video for the three-dimensional broadcasting which is closest to the viewer. The viewer can thus view a three-dimensional menu without feeling discomfort.

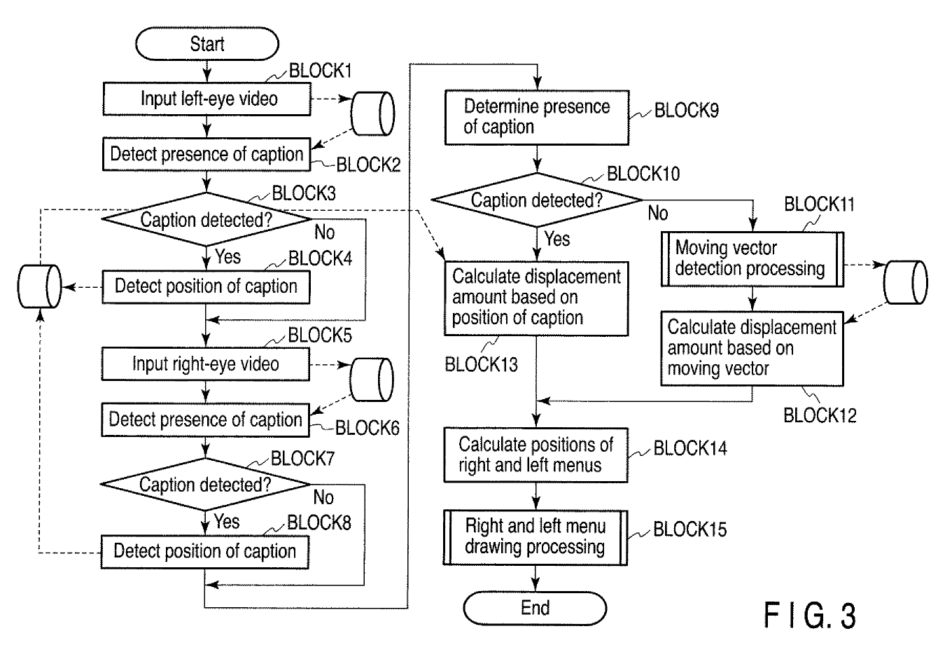

Now, with reference to the flowchart shown in FIG. 3, an example of three-dimensional video processing utilizing text information such as a caption or a ticker will be described.

If the video information for three-dimensional broadcasting contains text information such as a caption or a ticker, the degree of three-dimensionality is detected based on the text information. This is because the accuracy of the degree of three-dimensionality detected in text information (which is detected in video information) is often higher than that detected in video information. Accurate display information can be three-dimensionally displayed by setting the degree of three-dimensionality of the display information based on the degree of three-dimensionality detected in the text information.

First, the main control module 4 determines whether or not the three-dimensional broadcasting contains text information such as a caption or a ticker. That is, the left-eye video for the three-dimensional broadcasting is input to the main control module 4 (BLOCK 1). The main control module 4 determines whether or not the left-eye video contains any text information (BLOCK 2). Upon detecting text information in the left-eye video (BLOCK 3, YES), the main control module 4 detects the position of the detected text information (BLOCK 4). The position of the text information detected in the left-eye video is stored in RAM 12.

In parallel with the processing on the left-eye video, the right-eye video for the three-dimensional broadcasting is input to the main control module 4 (BLOCK 5). The main control module 4 determines whether or not the right-eye video contains any text information (BLOCK 6). Upon detecting text information in the right-eye video (BLOCK 7, YES), the main control module 4 detects the position of the detected text information (BLOCK 8). The position of the text information detected in the right-eye video is stored in RAM 12.

As described above, if the main control module 4 detects text information both in the right-eye video and in the left-eye video (BLOCK 9) (BLOCK 10, YES), the travel distance detection processing module 41 calculates the travel distance (displacement amount) between the text information in the right-eye video and of the text information in the left-eye video based on the position of the text information in the right-eye video and the position of the text information in the left-eye video (BLOCK 13).

The menu position calculation processing module 42 receives the menu display data input by flash RON 13. The menu position calculation processing module 42 then generates three-dimensional menu display data from the menu display data based on the travel distance detected by the travel distance detection processing module 41. That is, the menu position calculation processing module 42 calculates the display position of the right-eye menu and the display position of the left-eye menu based on the detected travel distance (BLOCK 14). The menu position calculation Processing module 42 thus generates right menu display data and left-eye menu display data. The right-eye menu drawing processing module 44 draws a right-eye menu based on the right-eye menu display data. The left-eye menu drawing processing module 43 draws a left-eye menu based on the left-eye menu display data (BLOCK 15).

Moreover, the main control module 4 superimposes the right-eye video for the three-dimensional broadcasting on the drawn right-eye menu to generate a right-eye superimposed video. The main control module 4 superimposes the left-eye video for the three-dimensional broadcasting on the drawn left-eye menu to generate a left-eye superimposed video. The liquid crystal glasses control module 8 and infrared emission section 9 notify the pair of glasses with the liquid crystal shutter of the driving timing for the liquid crystal shutter based on the video signal for the three-dimensional broadcasting. The liquid crystal glasses control module 8 and infrared emission section 9 further output the right-eye superimposed video and the left-eye superimposed video. In accordance with the provided driving timing for the liquid crystal shutter, the pair of glasses with the liquid crystal shutter drives the liquid crystal shutter to provide a three-dimensional video based on the right-eye superimposed video and the left-eye superimposed video. That is, the pair of glasses with the liquid crystal shutter displays a video frame displaying the left-eye superimposed video, for the left eye, while displaying a video frame displaying the right-eye superimposed video, for the right eye.

If the main control module 4 fails to detect text information in the right-eye video or in the left-eye video (BLOCK 9) (BLOCK 10, NO), the travel distance detection processing module 41 detects a moving vector based on the positions of the right-eye video and the left-eye video (BLOCK 11). The travel distance detection processing module 41 thus calculates the travel distance (displacement amount) between the right-eye video and the left-eye video (BLOCK 12). The menu position calculation processing module 42 receives the menu display data input by flash ROM 13. The menu position calculation processing module 42 then calculates the display position of the right-eye menu and the display position of the left-eye menu from the menu display data based on the travel distance detected by the travel distance detection processing module 41 (BLOCK 14). The menu position calculation processing module 42 thus generates right-eye menu display data and left-eye menu display data. The right-eye menu drawing processing module 44 draws a right-eye menu based on the right-eye menu display data. The left-eye menu drawing processing module 43 draws a left-eye menu based on the left-eye menu display data (BLOCK 15). Moreover, the main control module 4 superimposes the right-eye video for the three-dimensional broadcasting on the drawn right-eye menu to generate a right-eye superimposed video. The main control module 4 superimposes the left-eye video for the three-dimensional broadcasting on the drawn left-eye menu to generate a left-eye superimposed video.

FIG. 2 shows a case in which the travel distance is detected in a horizontally extended video. However, the travel distance may be detected in the video not extended yet.

In the above description, the pair of glasses with the liquid crystal shutter provides three-dimensional images. However, the present invention is not limited to this aspect. For example, the present invention is also applicable to a scheme in which three-dimensional video is provided using a micro lens stuck to a liquid crystal panel or a scheme in which three-dimensional videos is provided using a pair of polarizing glasses.

As described above, the digital-broadcast-compatible television can appropriately determine the degree of three-dimensionality of display information such as a menu based on the degree of three-dimensionality detected in three-dimensional broadcasting. The digital-broadcast-compatible television can thus three-dimensionally display a video for three-dimensional broadcasting and the display information. Thus, the viewer can view, without feeling discomforts a superimposed video in which the video for the three-dimensional broadcasting is superimposed on the three-dimensional display information. Furthermore, the digital-broadcast-compatible television also allows the display information to be three-dimensionally displayed in front of the video for the three-dimensional broadcasting (popup display) by setting the degree of three-dimensionality of the display information to a higher level.

Additionally, the digital-broadcast-compatible television appropriately sets the degree of three-dimensionality of the display information such as a menu based on the degree of three-dimensionality detected in the three-dimensional broadcasting, to three-dimensionally display the video for the broadcasting and the display information. The digital-broadcast-compatible television can thus deal with three-dimensional broadcasting with various degrees of three-dimensionality.

Moreover, the digital-broadcast-compatible television can display three-dimensional broadcasting on two screens. That is, the main control module 4 can control two-screen display. In this case, the travel distance detection processing module 41 can detect the travel distance of a three-dimensional video for each screen intended for the two-screen display. The menu position calculation processing module 42 can set the degree of three-dimensionality of display information based on the travel distance of the three-dimensional video for each screen. For example, the menu position calculation processing module 42 sets the degree of three-dimensionality of the display information to a large value such that the display information is three-dimensionally displayed in front of all the three-dimensional images for the respective screens. Thus, the display information can be three-dimensionally displayed in front of all the screens.

Moreover, the digital-broadcast-compatible television can display three-dimensional broadcasting on two framed screens. That is, the main control module 4 can control two-framed-screen display. In this case, the travel distance detection processing module 41 can detect the travel distance of a three-dimensional video for each screen intended for the two-framed-screen display. The menu position calculation processing module 42 can set the degree of three-dimensionality of each screen display frame based on the travel distance of the three-dimensional video for each screen. For example, the menu position calculation processing module 42 sets the degree of three-dimensionality of one of the screen display frames to a greater value, while setting the degree of three-dimensionality of the other screen display frame to a smaller value. Then, one of the screens is displayed in such a way as to be pushed out forward, while the other screen is displayed in such a way as to be pushed out backward.

The various modules of the TV described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A three-dimensional information output apparatus comprising:
a detection module configured to detect a degree of three-dimensionality of a three-dimensional video;
a generation module configured to generate three-dimensional information from display information based on the degree of three-dimensionality; and
an output module configured to output the three-dimensional display information.

2. The apparatus of claim 1, wherein the detection module is configured to detect the degree of three-dimensionality between a right-eye video and a left-eye video contained in the three-dimensional video provided by the three-dimensional broadcasting.

3. The apparatus of claim 1, wherein the detection module is configured to detect the degree of three-dimensionality between right-eye text information and left-eye text information contained in the three-dimensional video provided by the three-dimensional broadcasting.

4. The apparatus of claim 3, wherein the detection module is configured to detect the degree of three-dimensionality between the right-eye video and the left-eye video contained in the three-dimensional video provided by the three-dimensional broadcasting if the detection module fails to detect the degree of three-dimensionality between the right-eye text information and the left-eye text information.

5. The apparatus of claim 2, wherein the conversion module is configured to generate right-eye display information and left-eye display information from the display information based on the degrees of three-dimensionality.

6. The apparatus of claim 5, wherein the output module is configured to superimposedly output the right-eye video and the left-eye video, and the right-eye display information and the left-eye display information.

7. The apparatus of claim 1, wherein the generation module is configured to generate the three-dimensional display information from the display information used to display information on a menu based on the degrees of three-dimensionality.

8. The apparatus of claim 1, wherein the generation module is configured to generate the three-dimensional display information at a degree of dimensionality higher than that of the three-dimensional video.

9. A three-dimensional information output method comprising:
detecting a degree of three-dimensionality of a three-dimensional video;
generating three-dimensional information from display information based on the degree of three-dimensionality; and
outputting the three-dimensional display information.

10. The method of claim 9, wherein the degree of three-dimensionality is detected in each of a right-eye video and a left-eye video contained in three-dimensional broadcasting.
